(19) United States
(12) Patent Application Publication
(10) Pub. No.: US 2008/0067860 A1
(43) Pub. Date: Mar. 20, 2008

(54) CLADDING LUG WELL SLEEVE

(76) Inventor: Garry L. Van Houten, Middleville, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/855,743

(22) Filed: Sep. 14, 2007

Related U.S. Application Data
(60) Provisional application No. 60/825,768, filed on Sep. 15, 2006.

(51) Int. Cl. B60B 7/06

(52) U.S. Cl. 301/35.632; 301/37.101; 301/37.42

(57) ABSTRACT

A wheel assembly comprising a wheel having an outer surface and a plurality of exposed lug apertures located about a central hub region of the wheel, and a wheel cladding including a body conforming to the outer surface of the wheel that has an exposed decorative surface, an inner surface that faces the wheel when the cladding is attached to the wheel, and a plurality of lug wells that are axially aligned with the lug apertures of the wheel. The wheel assembly also includes a plurality of cladding lug well sleeves made from a high-temperature and ultraviolet light stable material that includes a plurality of snap-locking tabs for lockably fitting within the cladding lug wells. The cladding lug well sleeves are adapted to thermally insulate the cladding from the high temperatures of the lug nuts and studs from heat generated during vehicle operation.

### CROSS-REFERENCE TO RELATED APPLICATION

This application claims the benefit under 35 U.S.C. § 119(e) of U.S. Provisional Application No. 60/825,768, filed on Sep. 15, 2006, entitled “CLADDING LUG WELL SLEEVE,” the entire disclosure of which is hereby incorporated herein by reference.

### BACKGROUND OF THE INVENTION

The present invention relates to vehicle wheel assemblies, and in particular, to a wheel assembly including a wheel, a polymeric decorative wheel cladding and a heat insulating sleeve to protect the wheel cladding.

Ornamental metal-plated polymeric claddings have been employed for providing a decorative surface to the outer exposed surface of wheels for several years. U.S. Pat. Nos. 5,564,791; 5,577,809; 5,597,213; 5,630,654; 5,636,906; 5,845,973; and 6,085,829, the disclosures of which are incorporated herein by reference, represent different approaches for providing and attaching such claddings to existing wheels to provide a finished decorative appearing wheel. These wheel claddings offer design flexibility and allow wheel claddings of various configurations to be used to cover a single style metal wheel.

Heretofore, wheel coverings have been assembled with the associated vehicle wheel by a variety of clips and/or fasteners, many of which having a configuration such that the wheel cladding is in direct contact with at least a portion of the vehicle wheel proximate the hub aperture of the wheel. As a result, a significant amount of heat generated within the vehicle wheel during vehicle operations, such as breaking and the like is transferred from the fastener to the attached wheel cladding. The heat received by the wheel cladding may result in heat fatigue, and thereby reduce the useful life of the wheel clad, as well as distortion and degradation to the aesthetic outer covering associated therewith. Moreover, most previous coupling techniques that attempt to address the problem of heat transfer between the wheel and the wheel cladding are either unnecessarily complicated, or fail to provide a secure retention between the wheel and wheel cladding, thereby resulting in a non-robust design susceptible to fatigue and premature failure.

Therefore, there is a current need for an apparatus that insulates the wheel cladding from heat being transferred between the vehicle wheel and the wheel cladding, while simultaneously providing a secure connection between the vehicle wheel and the wheel cladding.

### SUMMARY OF THE INVENTION

One aspect of the present invention relates to a wheel assembly that includes a wheel having an outer surface and a plurality of exposed lug apertures located about a central hub region of the wheel, and a wheel cladding including a body conforming to the outer surface of the wheel, an exposed decorative surface, an inner surface facing the wheel when the cladding is attached to the wheel, and a plurality of lug wells extending axially toward the wheel. The wheel assembly also comprises a plurality of heat insulating sleeve members, each received into one of the plurality of lug wells and including a coupler portion that engages the cladding, thereby operably coupling each of the sleeve members to the wheel assembly.

Another aspect of the present invention relates to an insulating sleeve member for thermally insulating a wheel cladding from a wheel to which the wheel cladding is attached, the insulating sleeve member comprising a cylindrically-shaped body portion, a first end, and a second end including a coupler portion adapted to extend axially beyond the rearward edges of the lug wells.

Yet another aspect of the present invention relates to a wheel cladding assembly that comprises a wheel cladding including a body adapted to conform to an outer surface of a wheel, a decorative surface, an inner surface adapted to face an outer surface of a wheel when coupled thereto, and a plurality of axially-inwardly extending lug wells. The wheel cladding assembly further comprises a plurality of heat insulating sleeve members, each received into one of the plurality of lug wells and including a coupler portion adapted to engage the wheel cladding assembly. Yet still another aspect of the present invention provides a means for attaching a small diameter decorative center cap into the cladding itself.

The present inventive wheel assembly provides a durable, heat-resistant sleeve member to protect a wheel cladding that is attached to an associated wheel from heat and damage caused by lug nuts and lug studs. The wheel assembly may be easily and quickly assembled by even unskilled personnel, is economical to manufacture, capable of a long operating life, and is particularly well-adapted for the proposed use.

These and other advantages of the present invention will be further understood and appreciated by those skilled in the art by reference to the following written specification, claims, and appended drawings.

### BRIEF DESCRIPTION OF THE DRAWINGS

FIG. 1 is a perspective view of a wheel assembly embodying the present invention;

FIG. 2 is an exploded perspective view of the wheel assembly that includes a wheel cladding, a plurality of cladding lug well sleeves, and a small cap.

FIG. 3 is a front elevational view of the wheel assembly;

FIG. 4 is a cross-sectional view taken along the line IV-IV, FIG. 3;

FIG. 5 is a perspective view of one of the cladding lug well sleeves;

FIG. 6 is a side elevational view of the cladding lug well sleeve;

FIG. 7 is a top axial view of the cladding lug well sleeve; and

FIG. 8 is a cross-sectional view of the cladding lug well sleeve taken along line VIII-VIII, FIG. 7.

### DETAILED DESCRIPTION OF PREFERRED EMBODIMENTS

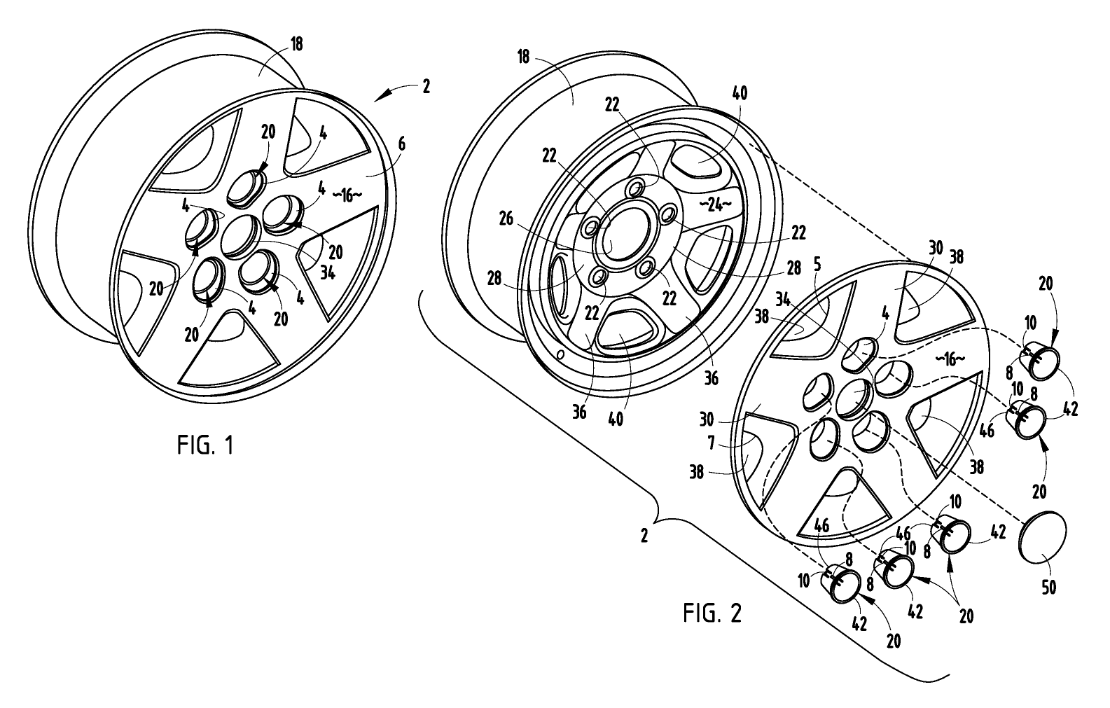

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations and step sequences, except where expressly specified to the contrary. It is also to be understood that the specific devices and processes illustrated in the attached drawings and described in the following specification are exemplary embodiments of the inventive concepts defined in the appended claims. Hence, relative dimensions and other physical characteristics relating to the embodiments disclosed herein are not to be considered as limiting, unless the claims expressly state otherwise.

The reference numeral 2 (FIGS. 1 and 2) generally designates a wheel assembly embodying the present invention. In the illustrated example, the wheel assembly comprises a wheel 18 including an outer surface 24 and a plurality of exposed lug apertures 22 located about a central hub region 28 of the wheel 18, and a wheel cladding 6 including a body 5 conforming to the outer surface 24 of the wheel 18, an exposed decorative surface 16, and an inner surface 7 facing the wheel 18 when the cladding 6 is coupled to the wheel 18, and a plurality of lug wells 4 extending axially inward toward the wheel 18. The wheel assembly 2 further comprises a plurality of heat insulative sleeve members 20, each received into one of the plurality of lug wells 4 and including a coupler portion 9 (FIG. 4) that engages the cladding 6, thereby operably coupling each of the sleeve members 20 with the cladding 6.

The wheel 18 of the composite wheel assembly 2 comprises aluminum, magnesium, steel, or other material conventionally used for manufacturing vehicle wheels. The cladding 6 of the wheel assembly 2 may be injection-molded from a polymeric material, such as ABS or the combination of polycarbonate and ABS having an average thickness of about two to four millimeters. Other polymeric materials may also be used. An outer decorative surface 16 of the cladding 6 is covered with a shiny or satin finish metal plating, such as chrome, as described in U.S. Pat. No. 6,749,946, issued Jun. 15, 2004, and entitled “Method and Composition for Metallic Finishes,” the disclosure of which is incorporated herein by reference. The outer surface 16 of the cladding 6 can also be painted, textured, or otherwise finished for a particular desired appearance.

The wheel 18 of the illustrated example includes a hub aperture 26 in a central hub region 28 and a plurality of exposed lug nut apertures 22 arranged in a circular pattern and spaced for the particular vehicle on which the composite wheel 2 is to be employed. The hub aperture 26 will typically be enclosed by a relatively small cap that is snapped into the cladding 6, while the lug nuts or lug bolts themselves (not shown) may be exposed once the wheel 2 is mounted to a vehicle.

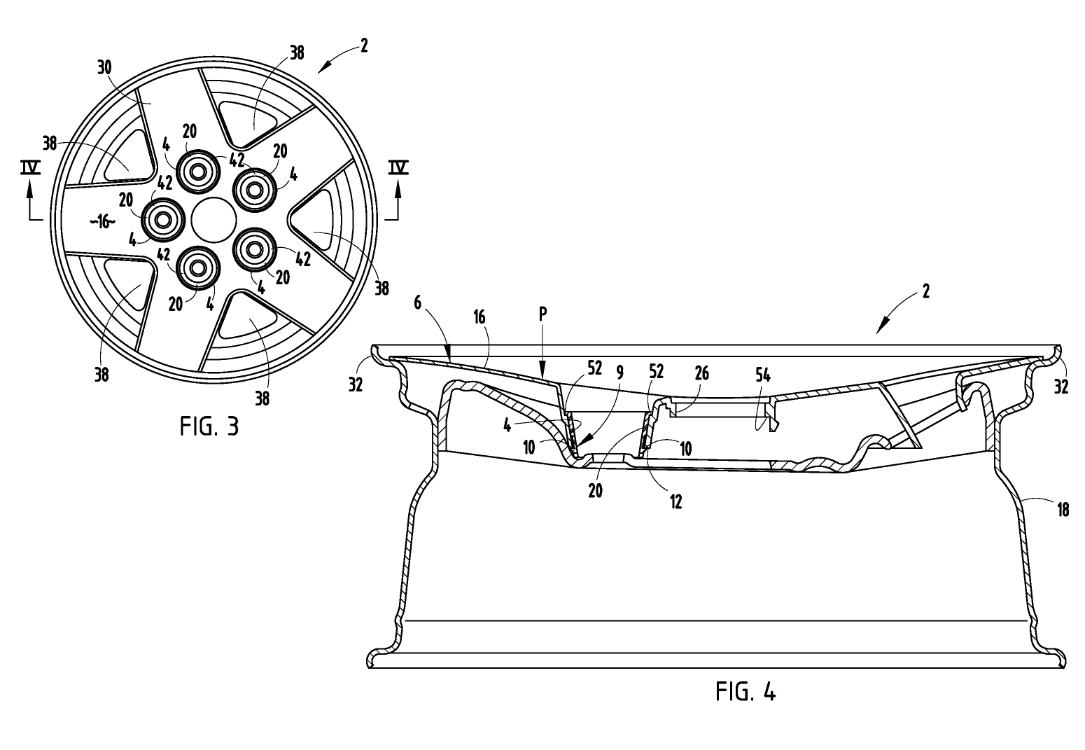

As illustrated, the cladding 6 (FIGS. 3 and 4) has a geometry which substantially conforms to that of the wheel 18, such that the cladding 6 matingly fits within a rim 32 of wheel 18, although other configurations may be utilized. A plurality of axially-spaced spokes 30 extend radially outwardly from a central hub opening 34, which correspond in size, shape, and location to a plurality of axially-spaced spokes 36 of the wheel 18. Between the spokes 30 of cladding 6 are spaces 38 shaped to conform to correspond to openings 40 in wheel 18 (FIG. 2). A central hub area surrounding a central hub aperture 34 of cladding 6 also includes a plurality of lug wells 4, which align with a corresponding plurality of lug bolt apertures 22 of the wheel 18 when the wheel cladding 6 is assembled with the wheel 18. The central hub aperture 34 of the cladding 6 is aligned with the aperture 26 when attached to the wheel 18. A small cap 50 (FIG. 2) is received by the cladding 6 to cover the central hub aperture 34. This cap 50 is coupled to the cladding 6, by snapping, using shoulder 54 (FIG. 4) on cladding 6, or other means. Once assembled, the cladding 6 appears as an integral outer surface of the wheel 18. The lug wells 4 of the cladding 6 define a wall, generally cylindrical in shape. The width of the lug wells 4 (FIG. 4) taper down from the outer decorative surface 16 to a rearward edge 12 of lug well 4.

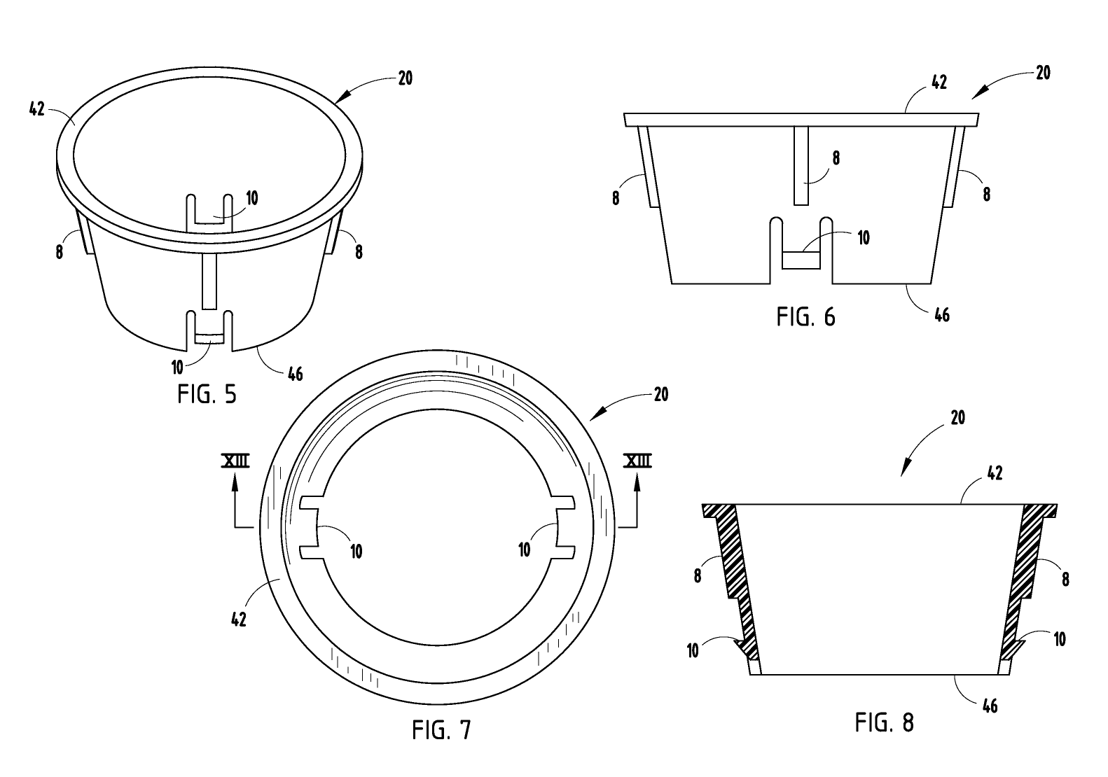

The cladding lug well sleeves 20 (FIGS. 5-8) are illustrated as generally cylindrical, however, other suitable configurations may be utilized. The width of each of the sleeves 20 may change between an upper end 42 and a lower end 46. For example, the width of the sleeve 20 may taper down between the upper end 42 and the lower end 46. In the illustrated example, the shape of the cladding lug well sleeve 20 should generally conform to the shape of the cladding lug well 4.

The coupler portion 9 includes a circumferentially and radially outward extending tab 10 that, when positioned within the associated lug well 4, abuts the rearward edge 12 of lug well 4 to ensure positive axial retention of the sleeve 20 within the lug well 4 of the cladding 6. In addition, the upper end 42 of sleeve 20 abuts a shoulder 52 formed in the lug well 4 of the cladding 6. The tab 10 of each sleeve member 20 further extends axially inward of the cladding lug well 4 in close proximity of the wheel 18. The cladding lug well sleeve 20 also provides support for the center of cladding 6 when it comes under clamp load P in certain tire changing equipment. The cladding lug well sleeve 20 will interface with wheel 18 when clamp load P is applied to cladding 6.

Each of the sleeve members 20 further includes one or more axially extending raised ribs 8 that are formed on the cladding lug well sleeve 20 to ensure a close fit between each cladding lug well sleeve 20 and the associated cladding lug well 4 to minimize rattling of the cladding lug well sleeve 20 within lug well 4. Circumferentially extending ribs (not shown) may be used with or in place of the axially extending raised ribs 8 to help ensure a close fit between the cladding lug well sleeve 20 and the cladding lug well 4.

In the embodiments illustrated in the figures, the material used to fabricate the sleeves 20 differs from that of the material used to fabricate the cladding 6 to maximize the properties of these materials in the location needed for the wheel assembly 2. More specifically, the cladding 6 is fabricated from a first material, which is inexpensive, lightweight, and capable of being painted or plated in a decorative fashion, as described above. Not needing to be decorated, the sleeves 20 are fabricated from a second material differing from the first material. The second material is selected from materials capable of withstanding temperatures generated by the vehicle lug nuts and lugs. Additionally, the second material could also be stable under ultraviolet light to reduce degradation thereof. The material may be any material, such as stainless steel, however, the materials are preferably selected from a thermoplastic injection-molded resin, such as nylon, or nylon reinforced with other materials, ASA, etc.

In the assembly, the sleeves 20 are inserted into the lug wells 4 of cladding 6 such that the tabs 10 of the sleeves 20 secure the sleeves 20 into the wheel assembly 2. In operation, heat generated within the wheel 18 due to vehicle operation, such as braking, is received by the sleeves 20, rather than directly by the cladding 6, thereby acting as a heat shield and reducing heat-induced fatigue or cosmetic problems to the cladding 6. The sleeves 20 further protect the cladding 6 from wear by providing a relatively wear-resistant surface in direct contact with the lug nut drivers or sockets during disassembly and reassembly of the wheel assembly 2, as necessitated by vehicle maintenance and repair.

The present inventive sleeve and associated wheel assembly provides a durable, heat-resistant and secure coupler of a wheel cladding sleeve to an associated cladding. The wheel assembly may be operated/installed by even unskilled personnel, can be easily and quickly assembled, is economical to manufacture, capable of long operating life while installed on an associated vehicle wheel, and is particularly well-adapted for the proposed use. Further, the wheel cladding assembly is significantly resistant to heat-induced fatigue, thereby reducing the chances of the cladding blistering, melting, peeling, or discoloring. Moreover, the sleeves help to provide support when a tire balancing machine applies pressure to the face of the cladding, due to the sleeve interfacing with the wheel. Additionally, this cladding design can allow for a small inexpensive center cap to be snappably installed into the cladding.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A wheel assembly comprising:
a wheel having an outer surface and a plurality of exposed lug apertures located about a central hub region of the wheel;
a wheel cladding including an exposed decorative surface, an inner surface facing the wheel when the cladding is coupled to the wheel, and a plurality of lug wells extending axially inward toward the wheel; and
a plurality of heat insulating sleeve members, each received into one of the plurality of lug wells and including a coupler portion that engages the cladding, thereby operably coupling each of the sleeve members with the cladding, and wherein each of the sleeve members is adapted to be entirely spaced from a lug nut receivable within the sleeve member.

2. The wheel assembly of claim 1, wherein the coupler portion of each of the plurality of sleeve members snap-engages the cladding.

3. The wheel assembly of claim 1, wherein the coupler portion of each of the sleeve members comprises a plurality of circumferentially-spaced tabs.

4. The wheel assembly of claim 1, wherein each sleeve member further includes at least one radially outwardly extending tab that abuts an outer surface of one of the lug wells.

5. The wheel assembly of claim 1, wherein each sleeve member comprises a material resistant to ultraviolet light degradation.

6. The wheel assembly of claim 1, wherein each sleeve member comprises a molded resin material.

7. The wheel assembly of claim 1, wherein the wheel cladding comprises a first material, and wherein each of the sleeve members comprises a second material that is different than the first material.

8. An insulating sleeve member for thermally insulating a wheel cladding from a wheel to which the wheel cladding is attached, the insulating sleeve member comprising:
a cylindrically shaped body portion that is adapted to be entirely spaced from a lug nut receivable within the sleeve member;
a first end; and
a second end including a coupler portion adapted to be received within a lug well of a wheel cladding, to extend axially inwardly of the lug well of a wheel cladding, and to engage the wheel cladding.

9. The sleeve member of claim 8, wherein the coupler portion is adapted to snap-engage the cladding.

10. The sleeve member of claim 8, wherein the coupler portion includes a plurality of circumferentially-spaced tabs.

11. The sleeve member of claim 8, wherein the body portion further includes at least one radially outwardly extending tab that abuts an outer surface of one of the lug wells.

12. The sleeve member of claim 8, wherein the body portion includes at least one axially extending raised rib adapted to engage an outer surface of a lug well of a wheel cladding.

13. The sleeve member of claim 8, wherein the sleeve member comprises a molded resin material.

14. The sleeve member of claim 8, wherein the sleeve member comprises a material resistant to ultraviolet light degradation.

15. A wheel cladding assembly comprising:
a wheel cladding including a body adapted to conform to an outer surface of a wheel, a decorative surface, an inner surface adapted to face an outer surface of a wheel when coupled thereto, and a plurality of axially inwardly extending lug wells; and
a plurality of heat insulating sleeve members, each received into one of the plurality of lug wells and including a coupler portion engaging the cladding, wherein each of the sleeve members is adapted to be entirely spaced from a lug nut receivable within the sleeve member.

16. The wheel cladding assembly of claim 15, wherein the coupler portion of each of the plurality of sleeve members is adapted to snap-engage the cladding.

17. The wheel cladding assembly of claim 15, wherein the coupler portion of each of the plurality of sleeve members includes a plurality of circumferentially-spaced tabs.

18. The wheel cladding assembly of claim 15, wherein each sleeve member includes at least one radially outwardly extending tab that abuts an outer surface of one of the lug wells.

19. The wheel cladding assembly of claim 15, wherein the wheel cladding comprises a first material and each of the sleeve members comprises a second material that is different than the first material.

20. The wheel cladding assembly of claim 15, wherein each of the sleeve members comprises a material that is resistant to ultraviolet light degradation.

21. The wheel cladding assembly of claim 15, wherein each sleeve member includes at least one axially extending raised rib that abuts an outer surface of one of the lug wells.

22. A wheel assembly comprising:
a wheel having an outer surface and a plurality of exposed lug apertures located about a central hub region of the wheel;
a wheel cladding including an exposed outer surface, an inner surface facing the wheel when the cladding is coupled to the wheel, and a plurality of lug wells extending axially inward toward the wheel; and
a plurality of heat insulating sleeve members, each received into one of the plurality of lug wells, each sleeve member comprising:
a cylindrically shaped body portion;
a first end; and
a second end including a coupler portion received within one of the lug wells of a wheel cladding, extending axially inwardly of the lug well of a wheel cladding and engaging the wheel cladding;
wherein the second end of each of the sleeve members is adapted to abut the outer surface of the wheel when an axially directed force is exerted on the outer surface of the wheel cladding and axially space the cladding member from the wheel proximate the sleeve members.

23. The wheel assembly of claim 22, wherein each of the sleeve members is adapted to be entirely spaced from a lug nut receivable within the sleeve member.

24. The wheel assembly of claim 22, wherein the coupler portion of each of the sleeve member includes a plurality of circumferentially-spaced tabs.

25. The wheel assembly of claim 22, wherein coupler portion of each of the sleeve members snap engages the cladding.
